(19) United States
(12) Patent Application Publication
(10) Pub. No.: US 2003/0081152 A1
(43) Pub. Date: May 1, 2003

(54) Multi-color liquid crystal display

(76) Inventors: Pin Chang, Hsinchu (TW); Heng-Chung Wu, Hsinchu Hsien (TW); Alex Lin, Junan Jen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,563

(22) Filed: Oct. 25, 2001

(51) Int. Cl. G02F 1/1347

(52) U.S. Cl. 349/74

(57) ABSTRACT

The present invention provides a multi-color liquid crystal display, wherein polarizing plates are disposed above, below, and between at least two liquid crystal displaying modules stacked up and down. The polarizing plates can be combinations of polarizing plates absorbing monochromatic light and general uncolored polarizing plates. Various kinds of colors can be achieved according to whether a voltage is applied onto the liquid crystal displaying modules. The present invention has a low price to apply to some portable products requiring less number of colors.

### FIELD OF THE INVENTION

The present invention relates to a display and, more particularly, to a portable color liquid crystal display (LCD) having a low manufacturing cost.

### BACKGROUND OF THE INVENTION

Along with increase of demand of portable communication products, compact displays have become point of importance of development in the communication industry. Most of conventional small LCDs such as panels of personal digital assistants (PDAs), mobile phones, and video games adopt the design of black-and-white display, hence having limited effect. Therefore, in order to achieve multi-color or full-color displaying effect, it is usually necessary to dispose a color filter in an LCD. Through the help of the color filter to display the three primary colors of red (R), green (G), and blue (B), full-color displaying mode can then be achieved by mixing different ratios of the three primary colors.

However, the color filter is expensive and has a high manufacturing cost. Because the required number of colors of the above small LCD is less, the price of this kind of products will go through the roof if the expensive color filter is applied to this kind of portable products, hence deteriorating the sell. Moreover, these small products have much limited display screens, and only need multi-color displaying effect.

Accordingly, the present invention aims to propose a multi-color LCD, which utilizes combinations and variations of polarizing plates to achieve multi-color displaying object so as to resolve the above problems.

### SUMMARY OF THE INVENTION

The primary object of the present invention is to propose a multi-color LCD comprising at least two liquid crystal displaying modules and a plurality of polarizing plates to apply to some portable products requiring less number of colors.

Another object of the present invention is to provide a multi-color LCD having a low price.

According to the present invention, a first polarizing plate, a second polarizing plate, and a third polarizing plate are disposed above, between, and below two liquid crystal displaying modules stacked up and down, respectively. The polarizing plates are generally combinations of uncolored polarizing plates and absorption-type polarizing plates only absorbing monochromatic light. Presentation of different colors of the display is controlled by whether a voltage is applied onto the two liquid crystal displaying modules.

The various objects and advantages of the present invention will be more readily understood from the following detailed description when read in conjunction with the appended drawings, in which:

### BRIEF DESCRIPTION OF THE DRAWINGS

FIG. 1 is a structure diagram of a three-color LCD of the present invention;

FIGS. 2a to 2d show diagrams of four driving modes of FIG. 1;

FIG. 3 is a structure diagram of a four-color LCD of the present invention;

FIGS. 4a to 4d show diagrams of four driving modes of FIG. 3;

FIG. 5 is a structure diagram of a multi-color LCD of the present invention;

FIG. 6 is a structure diagram of a reflective multi-color LCD of the present invention; and

FIGS. 7a to 7d show diagrams of four driving modes of FIG. 6.

### DETAILED DESCRIPTION OF THE PREFERRED EMBODIMENTS

The present invention adopts the design of more than two liquid crystal displaying modules matched with a set of polarizing plates to let an LCD achieve multi-color displaying object. A three-color LCD, a four-color LCD, and an RGB multi-color LCD will be described below to illustrate characteristics of the present invention.

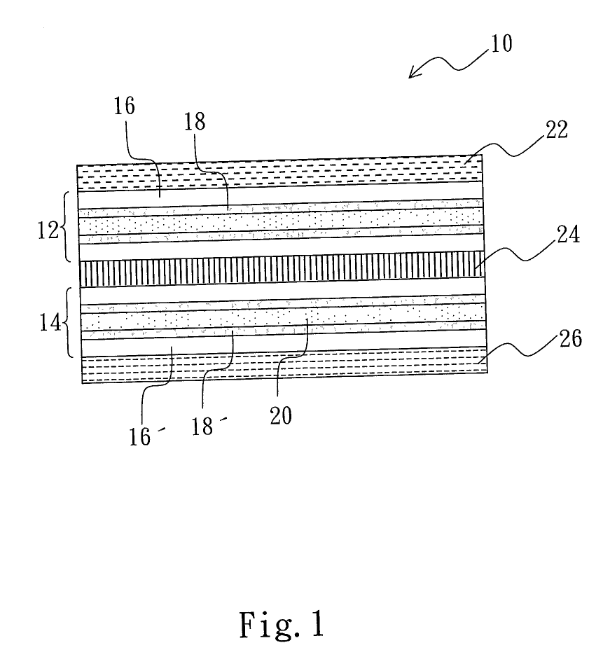

As shown in FIG. 1, a multi-color LCD comprises a first liquid crystal displaying module 12 and a second liquid crystal displaying module 14. In each of the two liquid crystal displaying modules 12 and 14, transparent electrode layers 18 and 18′ are disposed on two opposite surfaces of an upper transparent substrate 16 and a lower transparent substrate 16′, which are parallel spaced. A liquid crystal layer 20 is disposed between the two transparent substrates 16 and 16′. A first polarizing plate 22 and a second polarizing plate 24 are pasted on outer surfaces of the upper and lower transparent substrates 16 and 16′ of the first liquid crystal displaying module 12, respectively. Polarization directions of the first and second polarizing plates 22 and 24 are normal to each other. The upper transparent substrate 16 of the second liquid crystal displaying module 14 is disposed below the second polarizing plate 24 so that light passing through the second polarizing plate 24 can enter the second liquid crystal displaying module 14. A third polarizing plate 26 is pasted on the outer surface of the lower transparent substrate 16′ of the second liquid crystal displaying module 14. Polarization directions of the second and third polarizing plates 24 and 26 are normal to each other. The first and second polarizing plates 22 and 24 are generally uncolored polarizing plates, which let light with a polarization direction parallel to the polarization directions thereof pass through, and absorb light with a polarization direction perpendicular to the polarization directions thereof. The third polarizing plate 26 is an absorption-type polarizing plate only absorbing monochromatic light.

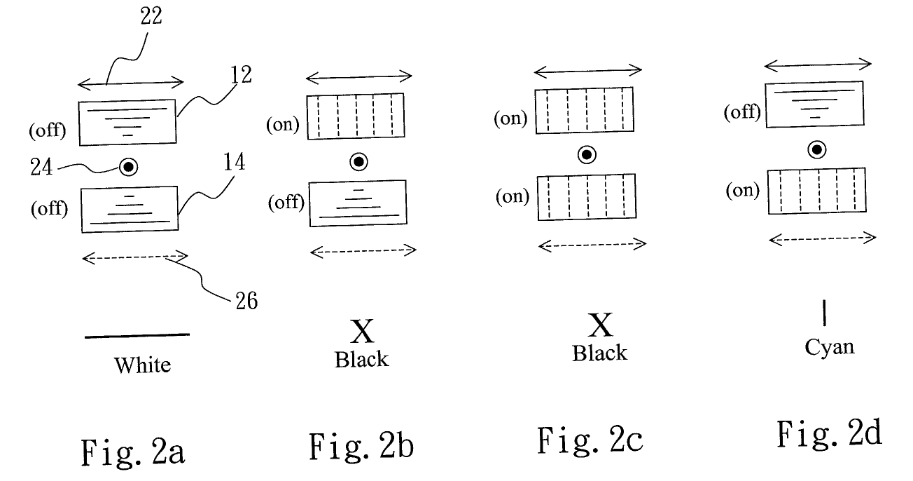

When the transparent electrode layers 18 and 18′ are off, liquid crystal molecules of the liquid crystal layer 20 will align toward a certain direction according the direction of thin trenches of an orientation film, and twist 90 degrees between the upper and lower transparent electrodes 18 and 18′. When the transparent electrode layers 18 and 18′ are on, the alignment direction of liquid crystal molecules will be altered to be parallel to the electric field. In the present invention, presentation of different colors is controlled by whether a voltage is applied onto the two liquid crystal displaying modules 12 and 14. FIGS. 2a to 2d show four driving modes of the two liquid crystal displaying modules 12 and 14. The polarization directions of the first, second, and third polarizing plates 22, 24, and 26 are parallel to (denoted by ←---→), perpendicular to (denoted by ⊙), and parallel to (denoted by ←- - - →) the paper, respectively. The third polarizing plate 26 is a monochromatic polarizing plate only absorbing the red light.

When an incident light enters the first polarizing plate 22 and is converted to a polarized light parallel to the paper (as shown in FIG. 2a), if no voltage is applied onto the two liquid crystal displaying module 12 and 14, the polarized light parallel to the paper incident from the first polarizing plate 22 into the first liquid crystal displaying module 12 will rotate 90 degrees along with liquid crystal molecules to form a polarized light perpendicular to the paper, which successfully passes through the second polarizing plate 24 and then is incident into the second liquid crystal displaying module 14 to rotate 90 degrees along with liquid crystal molecules to form a polarized light parallel to the paper, which successfully passes through the third polarizing plate 26. A white color is thus shown. If a voltage is applied onto the first liquid crystal displaying module 12 (as shown in FIGS. 2b and 2c), no matter whether a voltage is applied onto the second liquid crystal displaying module 14, the polarized light parallel to the paper incident from the first polarizing plate 22 into the first liquid crystal displaying module 12 will not rotate so as to be blocked by the second polarizing plate 24, and thus cannot enter the second liquid crystal displaying module 14. A black color is thus shown. Similarly, when no voltage is applied onto the first liquid crystal displaying module 12 while a voltage is applied onto the second liquid crystal displaying module 14 (as shown in FIG. 2d), the polarized light parallel to the paper incident from the first polarizing plate 22 into the first liquid crystal displaying module 12 will rotate 90 degrees along with liquid crystal molecules to form a polarized light perpendicular to the paper, which successfully passes through the second polarizing plate 24 to enter the second liquid crystal displaying module 14. Because not rotated by liquid crystal molecules, after the polarized light perpendicular to the paper passes through the third polarizing plate 26, its red light will be absorbed so that a complementary cyan color is shown.

The above liquid crystal displaying modules 12 and 14 can be twisted-nemaic (TN) modules or other liquid crystal displaying modules. Phase-compensating sheets (not shown) can be disposed on upper and lower surfaces of the first, second, and third polarizing plates 22, 24, and 26. The monochromatic absorption spectrum of the third polarizing plate 26 can be arbitrarily chosen according to necessity to let the display show a white color, a black color, and a complementary color of the selected absorbed light of the third polarizing plate 26. The number of displayed colors can be increased by matching gray scale contrasts. Additionally, the above structures can be arbitrarily replaced to apply to transmission type, reflective type, and transflective type LCDs.

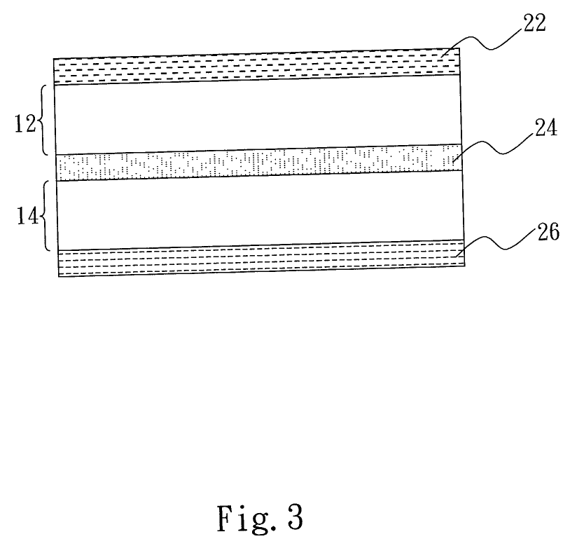

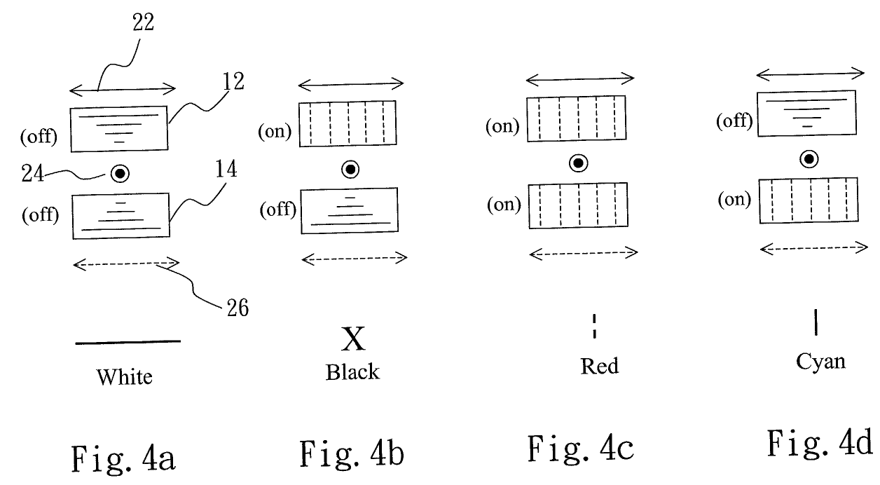

Similarly, a four-color LCD has a structure approximately the same as above. As shown in FIG. 3, a first liquid crystal displaying module 12 and a second liquid crystal displaying module 14 are stacked up and down. A first polarizing plate 22, a second polarizing plate 24, and a third polarizing plate 26 are disposed above, between, and below the two liquid crystal displaying modules 12 and 14. The first polarizing plate 22 is generally an uncolored polarizing plate. The second and third polarizing plates 24 and 26 are absorption-type polarizing plates only absorbing monochromatic light. The absorption spectrum of the second and third polarizing plates 24 and 26 can be arbitrarily chosen. If the absorption spectrum of the second and third polarizing plates 24 and 26 are respectively cyan and its complementary red color, when no voltage is applied onto the two liquid crystal displaying modules 12 and 14 (as shown in FIG. 4a), the polarized light parallel to the paper incident from the first polarizing plate 22 into the first liquid crystal displaying module 12 will successfully pass through the second and third polarizing plates 24 and 26 to show a white color. When a voltage is applied onto the first liquid crystal displaying module 12 while no voltage is applied onto the second liquid crystal displaying module 14 (as shown in FIG. 4b), the cyan light of the polarized light parallel to the paper incident from the first polarizing plate 22 will be absorbed after passing through the second polarizing plate 24 so that only the red light of the polarized light parallel to the paper enters the second liquid crystal displaying module 14 and is then rotated 90 degrees to form a polarized light perpendicular to the paper, which will thus be blocked by the third polarizing plate 26 to show a black color. If a voltage is applied onto both the first and second liquid crystal displaying modules 12 and 14 (as shown in FIG. 4c), the red light of the polarized light parallel to the paper incident from the first polarizing plate 22 will not be rotated after entering the second liquid crystal displaying module 14, and will successfully pass through the third polarizing plate 26 to show a red color. Similarly, when no voltage is applied onto the first liquid crystal displaying module 12 while a voltage is applied onto the second liquid crystal displaying module 14 (as shown in FIG. 4d), the polarized light parallel to the paper incident from the first polarizing plate 22 will be rotated 90 degrees to form a polarized light perpendicular to the paper after passing through the first liquid crystal displaying module 12 so as to successfully pass through the second polarizing plate 24. The red light of the polarized light perpendicular to the paper will then be absorbed by the third polarizing plate 26 to show a cyan color. This display can thus display a white color, a black color, a red color, and a cyan color. A multi-color display can be obtained through mixing different ratios of colors and matching gray scale contrasts.

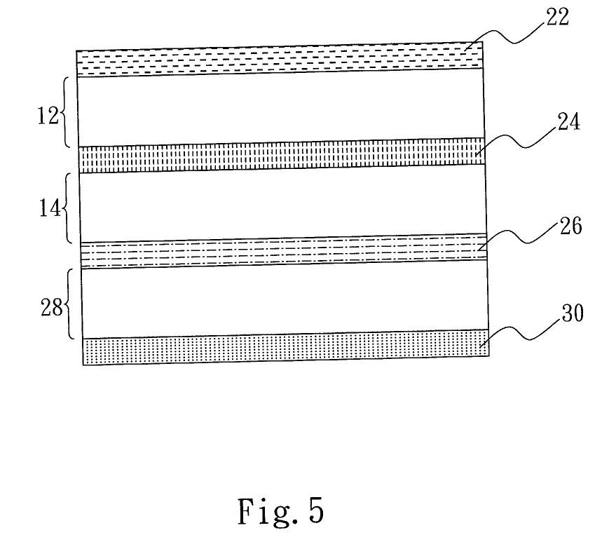

As shown in FIG. 5, a multi-color LCD can comprise three liquid crystal displaying modules 12, 14, and 28 stacked up and down. A first, a second, a third, and a fourth polarizing plates 22, 24, 26, and 30 are disposed above the first liquid crystal displaying module 12, between the first and second liquid crystal displaying modules 12 and 14, between the second and third liquid crystal displaying modules 14 and 28, and below the third liquid crystal displaying module 28, respectively. The first polarizing plate 22 is generally an uncolored polarizing plate. The second, third, and fourth polarizing plates 24, 26, and 30 are polarizing plates absorbing red light, green light, and blue light, respectively. Eight configurations depending on whether a voltage is applied onto the three liquid crystal displaying modules 12, 14, and 28 are used to generate a white color, a black color, a red color, a cyan color, a green color, a purple color, a blue color, and a yellow color, respectively. Multi-color display can be achieved by matching gray scale contrasts.

The present invention utilizes the combination of liquid crystal displaying modules and polarizing plates to achieve multi-color displaying effect without the need of an expensive color filter, hence lowering the cost and widely applying to display panels of portable products such as mobile phones, video games, PDAs, watches, and calculators.

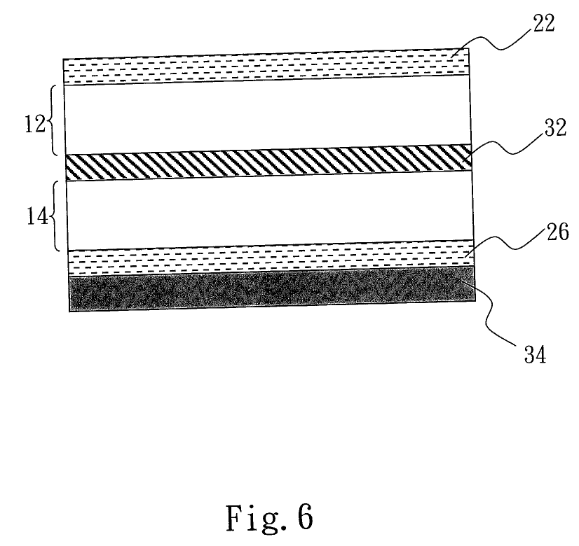

Additionally, as shown in FIG. 6, a reflective type multi-color LCD comprises a first liquid crystal displaying module 12 and a second liquid crystal displaying module 14 stacked up and down. An optical polarizing plate 32 having a polarization direction perpendicular to the paper is disposed between the two liquid crystal displaying modules 12 and 14. A first polarizing plate 22 and a third polarizing plate 26 are disposed above the first liquid crystal displaying module 12 and below the second liquid crystal displaying module 14, respectively. The first and third polarizing plates 22 and 26 are generally uncolored polarizing plates. The polarization direction of the first and third polarizing plates 22 and 26 is normal to that of the optical polarizing plate 32 and parallel to the paper. A colored reflective layer 34 is disposed on the lower surface of the third polarizing plate 26.

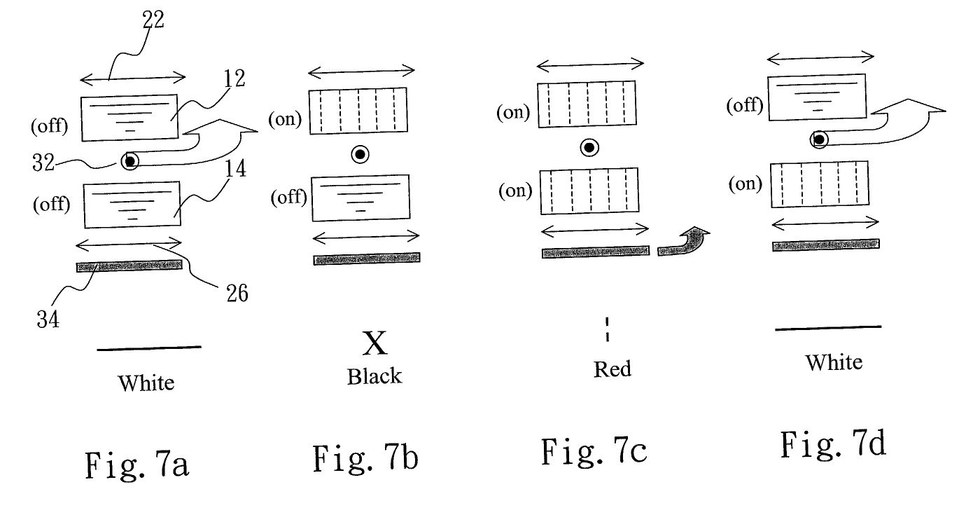

The above optical polarizing plate 32 reflects light having a polarization direction perpendicular to the paper, and lets light having a polarization direction parallel to the paper pass through. Operation of this embodiment of the present invention will be illustrated through four driving modes of the two liquid crystal displaying modules 12 and 14 matched with a red reflective layer 34. As shown in FIG. 7a, if no voltage is applied onto each of the two liquid crystal displaying modules 12 and 14, the polarized light parallel to the paper incident from the first polarizing plate 22 into the first liquid crystal displaying module 12 will rotate 90 degrees along with liquid crystal molecules to become a polarized light perpendicular to the paper, which is then reflected back by the optical polarizing plate 32 to show a white color. When a voltage is applied on the first liquid crystal displaying module 12 while no voltage is applied onto the second liquid crystal displaying module 14 (as shown in FIG. 7b), the polarized light parallel to the paper incident from the first polarizing plate 22 into the first liquid crystal displaying module 12 will pass through the optical polarizing plate 32 and enter the second liquid crystal displaying module 14 to rotate 90 degrees along with liquid crystal molecules to become a polarized light perpendicular to the paper, which is then blocked by the third polarizing plate 26. A black color is thus shown. If a voltage is applied onto each of the two liquid crystal displaying modules 12 and 14 (as shown in FIG. 7c), the polarized light parallel to the paper that enters the second liquid crystal displaying module 14 will pass through the third polarizing plate 26, and then be reflected by the red reflective layer 34 to show a red color. Similarly, when no voltage is applied onto the first liquid crystal displaying module 12 while a voltage is applied onto the second liquid crystal displaying module 14 (as shown in FIG. 7d), the polarized light parallel to the paper incident from the first polarizing plate 22 into the first liquid crystal displaying module 12 will be directly reflected back by the optical polarizing plate 32 to shown a white color.

In addition to being a reflective layer with color itself, the above colored reflective layer 34 can be a reflective layer on which a glue having color dye added therein is applied. The color dye can be arbitrarily chosen according to necessity. Additionally, a dyed layer can be disposed on the lower surface of the optical polarizing plate to achieve displaying effect of more colors.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-color liquid crystal display, comprising:
at least two liquid crystal displaying modules stacked up and down; and
at least three polarizing plates being a first, a second, and a third polarizing plates disposed above said upper liquid crystal displaying module, between said two adjacent liquid crystal displaying modules, and below said lower liquid crystal displaying module, said first polarizing plate converting an incident light into a unidirectional polarized light, said second and third polarizing plates being polarizing plates absorbing different monochromatic colors.

2. The multi-color liquid crystal display as claimed in claim 1, wherein disposition positions and polarization directions of said polarizing plates can be arbitrarily arranged and combined.

3. The multi-color liquid crystal display as claimed in claim 1, wherein one of said second and third polarizing plates can further be an uncolored polarizing plate to let a polarized light parallel to the polarization direction thereof pass through and to absorb a polarized light perpendicular to the polarization direction thereof.

4. The multi-color liquid crystal display as claimed in claim 1, wherein a colored or uncolored reflective layer can be disposed below said third polarizing plate to form a reflective type display.

5. The multi-color liquid crystal display as claimed in claim 1, wherein said polarizing plates can be replaced with non-absorption-type polarizing plates.

6. The multi-color liquid crystal display as claimed in claim 1, wherein said liquid crystal displaying modules can be twisted-nemaic modules or other liquid crystal displaying modules.

7. The multi-color liquid crystal display as claimed in claim 1, wherein at least a phase-compensating sheet can further be disposed on upper and lower surfaces of any one of said polarizing plates.

8. A multi-color liquid crystal display, comprising:
two liquid crystal displaying modules stacked up and down; and
a first and a second polarizing plates disposed above and below said two liquid crystal displaying modules, respectively;
an optical polarizing plate disposed between said two liquid crystal displaying modules, said optical polarizing plate being used to reflect a polarized light parallel to the polarization direction thereof and to let a polarized light perpendicular to the polarization direction thereof pass through; and
a colored reflective layer disposed below said second polarizing plate.

9. The multi-color liquid crystal display as claimed in claim 8, wherein said colored reflective layer is formed by disposing a glue on a surface of a reflective layer, and color dye is added in said glue.

10. The multi-color liquid crystal display as claimed in claim 8, wherein a dyed layer can further be disposed on a lower surface of said optical polarizing plate.

11. The multi-color liquid crystal display as claimed in claim 8, wherein said liquid crystal displaying modules can be twisted-nemaic modules or other liquid crystal displaying modules.

12. The multi-color liquid crystal display as claimed in claim 8, wherein at least a phase-compensating sheet can further be disposed on upper and lower surfaces of any one of said polarizing plates.

13. The multi-color liquid crystal display as claimed in claim 8, wherein said polarizing plates can be polarizing plates absorbing monochromatic light.
